(19) United States
(12) Patent Application Publication
(10) Pub. No.: US 2018/0295833 A1
(43) Pub. Date: Oct. 18, 2018

(54) METHOD FOR SUPPRESSION OF OR PROTECTION FROM ISCHEMIA/REPERFUSION INJURY OF ORGANS FOR TRANSPLANTATION

(71) Applicants: MiZ Company Limited, Kamakura-shi (JP); KYOTO UNIVERSITY, Kyoto-shi (JP)

(72) Inventors: Koichiro HATA, Kyoto-shi, Kyoto (JP); Ichiro TAMAKI, Kyoto-shi (JP); Yusuke OKAMURA, Kyoto-shi (JP); Shinji UEMOTO, Kyoto-shi (JP); Shinichi HIRANO, Kamakura-shi (JP); Bunpei SATOH, Kamakura-shi (JP)

(21) Appl. No.: 15/950,383

(22) Filed: Apr. 11, 2018

(30) Foreign Application Priority Data
Apr. 12, 2017 (JP) 2017-078658

(51) Int. Cl. A01N 1/02

(52) U.S. Cl. CPC A01N 1/021

(57) ABSTRACT

The present application provides a method for preventing or protecting an organ from ischemia-reperfusion injury, the method comprising a step of perfusing an organ harvested for transplant ex vivo with a solution containing molecular hydrogen via a blood vessel thereof.

The patent or application file contains at least one drawing executed in color. Copies of this patent or patent application publication with color drawing(s) will be provided by the Office upon request and payment of the necessary fee.

### RELATED APPLICATIONS

The present application claims priority of Japanese Patent Application No. 2017-078658 (filed on Apr. 12, 2017). The content of the application is incorporated herein by reference in its entirety.

### BACKGROUND OF THE INVENTION

### 1. Field of the Invention

The present invention relates to a method for preventing or protecting an organ from ischemia-reperfusion injury, the method comprising perfusing an organ harvested for transplant ex vivo with a solution containing molecular hydrogen via a blood vessel thereof.

The present invention also relates to a method for treating an organ, the method comprising cold preserving an organ harvested for transplant and then perfusing the cold-preserved organ ex vivo with a solution containing molecular hydrogen via a blood vessel thereof.

The present invention further relates to an ischemia-reperfusion injury protection agent for an organ for transplant, the agent comprising a solution containing molecular hydrogen.

### 2. Description of the Related Art

Human life is maintained by the actions of various organs such as the heart, lungs, liver, and kidneys. If the functions of these organs are lost due to an illness or an accident, a significant impact on lifestyle or life support occurs. Accordingly, a person whose organ function has been lost or decreased due to a serious illness or an accident may undergo an organ transplant medical procedure that restores the function by replacing the organ with a healthy organ of another person.

On another front, regenerative medicine is carried out using cells or tissues cultured outside the patient's body in order to restore and regenerate a tissue or organ that is defective, damaged, or functionally damaged naturally or due to disease, accident, aging, or other reasons. Recently, regenerative medicine using stem cells, such as ES cells, iPS cells, or somatic stem cells, has attracted attention and has been positioned as a promising medical technology that may replace organ transplantation. However, it will still be some time before it is put into practical use, and it has not reached the point of becoming a substitute.

In recent years, in Japan, the requirements for organ transplant after brain death were relaxed by revision of the Organ Transplant Law. Furthermore, in addition to the revision of the law, the types of organs that can be transplanted have increased compared to before by progress in, for example, medical technology and immunosuppressants, and the transplant results are also improving. However, there are many people who need a transplant in Japan, but the number of organ donors after brain death is small compared to those in Western countries. There is thus a problem that the number of people who actually receive transplants in Japan is very small.

In organ transplantation, some problems arise. A typical problem among them is ischemia-reperfusion injury. This injury occurs in the process of transplanting an organ which has been harvested from a donor (organ donor) and preserved for organ transplant into a recipient (organ recipient) and resuming blood flow. It is inferred that the injury is further amplified by, for example, generation of various toxic substances, such as reactive oxygen species (ROS), by reperfusion (blood flow resuming) in the organ or tissue in an ischemic condition (ischemic injury).

In ischemia-reperfusion injury, the degree of the injury varies depending on, for example, the time and degree of ischemia and the type of the organ. It is known that there are several causes and that a major cause is a sudden supply of oxygen to the ischemic tissue, which causes various physiological responses including generation of active oxygen and free radicals, infiltration of neutrophils, and platelet activation, and worsens the organ injury. If the injury is serious, the organ will fall into transplanted organ dysfunction (primary non-function: PNF) or functional delay and damage after transplant (delayed graft dysfunction: DGF, early allo-grafi dysfunction: EAD). These dysfunctions are more prominent in organs harvested from donors after cardiac death, donors with moderate or more severe fatty liver, or elderly donors, which are called marginal organs (extended criteria donors). Furthermore, injury (remote organ injury) may occur secondarily in major organs of the whole body, as well as locally occurring injury. In particular, organs such as the brain, lungs, liver, and kidneys are targeted, and multiple organ failure may occur.

The most widely used method for preserving organs is currently a simple cold preservation method in which an organ is subjected to flushing (perfusion) of the inside of the organ with a cold organ preservation solution for preventing cellular metabolism and is then immersed in a cold preservation solution. In addition, continuous supplies of oxygen and nutrients to organs being preserved or perfusion preservation methods at various temperatures for removing waste products have been developed. However, these methods also still have many problems to be solved from the viewpoints of high medical expenses, complex systems, poor transportability, and so on, and the methods have not been widely adopted.

In recent years, it has been demonstrated that hydrogen as a reducing agent selectively reacts with hydroxyl radical (—OH) and a peroxynitrite (ONOO⁻), which are active oxygen species having high reactivity, to reduce and eliminate them. It is known that when hydrogen gas is inhaled from the lung, hydrogen spreads throughout the body by diffusion or blood flow to prevent diseases relating to active oxygen and reduce and eliminate free radicals having strong oxidizability causing cell damage. It has been reported that in rat models of cerebral infarction and liver ischemia reperfusion, organ and tissue injury can be decreased by hydrogen (Japanese Patent No. 5106110).

Japanese Patent No. 5581500 describes a gaseous pharmaceutical composition for inhalation for reducing ischemia-reperfusion injury, the composition containing oxygen, hydrogen, and nitrogen monoxide, with the balance being an inert gas. An Example shown in Japanese Patent No. 5581500 uses a mouse model of myocardial ischemia-reperfusion injury and describes that a combination of hydrogen and nitrogen monoxide can reduce infiltration of neutrophils and platelet activation.

Japanese Patent Laid-Open No. 2018-16654 describes a method for preserving a biomaterial, the method including preservation of a biomaterial, such as organs and cells, in a medical gas and aerosol atmosphere. An Example shown in Japanese Patent Laid-Open No. 2018-16654 uses a gas mixture of carbon monoxide and oxygen as the medical gas and uses a rat heart as the biomaterial.

### SUMMARY OF THE INVENTION

Among conventional methods of applying hydrogen aimed at protection from ischemia-reperfusion injury, methods in which a donor organ is preserved in an organ preservation solution containing hydrogen for a certain period of time and is then perfused with a perfusate not containing hydrogen have mainly been employed. Such methods can prevent the donor organ from injury due to ischemia but cannot lead to prevention of reperfusion injury. An organ preservation method and an organ perfusion method aimed at more effective protection from ischemia-reperfusion injury have been desired.

Furthermore, prior art documents including Japanese Patent No. 5106110, Japanese Patent No. 5581500 and Japanese Patent Laid-Open No. 2018-16654 disclose that ischemia-reperfusion injury of a transplanted donor organ is treated by administration of molecular hydrogen. In contrast to this, however, there is no description that ischemia-reperfusion injury of a transplanted donor organ can be prevented or protected by perfusing the donor organ before transplant ex vivo with a solution containing molecular hydrogen via a blood vessel thereof, and this fact has not been known hitherto.

The present inventors have diligently studied to solve the above-described problems and as a result, have found a method for preventing ischemia-reperfusion injury of an organ comprising perfusing the harvested organ ex vivo with an ischemia-reperfusion injury protection agent including a solution containing molecular hydrogen, or with a solution containing molecular hydrogen via a blood vessel thereof, and a method for treating an organ comprising cold preserving a harvested organ and then perfusing the organ ex vivo with a solution containing molecular hydrogen via a blood vessel thereof.

Specifically, the present invention encompasses the following characteristics:

(1) A method for preventing or protecting an organ from ischemia-reperfusion injury, the method comprising a step of perfusing an organ harvested for transplant ex vivo with a solution containing molecular hydrogen via a blood vessel thereof;

(2) A method for treating an organ, the method comprising the steps of: cold preserving of an organ harvested for transplant and perfusing the cold-preserved organ ex vivo with a solution containing molecular hydrogen via a blood vessel thereof;

(3) The method according to the above (1) or (2), wherein the solution is an organ preservation solution;

(4) he method according to the above (1) or (2), wherein the concentration of molecular hydrogen in the solution containing molecular hydrogen is 1.6 ppm or less;

(5) The method according to the above (1) or (2), wherein the period of time for perfusing the harvested organ ex vivo with the solution containing molecular hydrogen via the blood vessel thereof is 5 minutes to 1 hour;

(6) The method according to the above (1) or (2), wherein the blood vessel of the harvested organ is a portal vein and/or a hepatic artery;

(7) An ischemia-reperfusion injury protection agent for an organ for transplant, the agent comprising a solution containing molecular hydrogen;

(8) The protection agent according to the above (7), wherein the concentration of molecular hydrogen in the solution containing molecular hydrogen is 1.6 ppm or less; and

(9) The protection agent according to the above (7), wherein the solution is an organ preservation solution.

As shown in Examples described below, ischemia-reperfusion injury is significantly prevented or protected by harvesting rat liver, cold preserving the rat liver in an organ preservation solution, and then performing a hydrogen perfusion method (Hydrogen Perfusion After Cold Storage: HyPACS method) in which the liver is perfused ex vivo with a solution containing molecular hydrogen via a portal vein and/or a hepatic artery. The method of the present invention can be applied to other organs.

In the present specification, the term “ischemia-reperfusion injury” encompasses injury that is generally defined in the medical field regarding organ transplant. Specifically, this injury occurs in the process of transplanting an organ, which has been harvested from a donor and preserved for organ transplant, into a recipient and resuming blood flow. The injury is further amplified in an organ (and its tissue) in an ischemic condition (ischemic injury) by reperfusion (blood flow resuming), which generates various toxic substances, for example, reactive oxygen species (ROS), such as super oxide, hydroxyl radical, and peroxynitrite, and chemical mediators, such as cytokine. In ischemia-reperfusion injury, the degree of the injury varies depending on, for example, the time and degree of ischemia and the type of the organ. Examples of this injury include injury by generation of reactive oxygen species or oxidative stress; injury by chemical mediator production; injury by neutrophil activation or platelet activation; vascular endothelial cell injury; microcirculation injury; organ injury; transplanted organ dysfunction (primary non-function: PNF); functional delay and damage after transplant (delayed graft dysfunction: DGF, early allo-graft dysfunction: EAD); remote organ injury; and multiple organ failure.

### BRIEF DESCRIPTION OF THE DRAWINGS

FIGS. 1A to 1C are graphs showing influences on release of transaminase and lactate dehydrogenase, which are hepatocellular injury markers, into perfusates when livers harvested from rats were each cold preserved (4° C.) in a UW solution for 24 hours and then perfused with Ringer's solution with a hydrogen concentration of 1 ppm via the blood vessel of the liver. In the graphs, ● indicates the control groups (perfusion with Ringer's solution not containing hydrogen via the portal vein); ▪ indicates H₂—PV groups (perfusion with Ringer's solution containing hydrogen via the portal vein); A indicates H₂-HA groups (perfusion with Ringer's solution containing hydrogen via the hepatic artery); and ▾ indicates H₂—PV+HA groups (perfusion with Ringer's solution containing hydrogen via both a portal vein and a hepatic artery). FIG. 1A shows changes in the level (IU/L) of aspartate aminotransferase (AST) released into the perfusate at elapsed time (0 to 120 minutes) after reperfusion. Similarly, FIG. 1B shows changes in the levels (IU/L) of alanine aminotransferase (ALT), and FIG. 1C shows changes in the level (IU/L) of lactate dehydrogenase (LDH). The statistical analysis was performed by two-way repeated measures analysis of variance (2-way repeated measured ANOVA). The P value indicates significance probability.

FIG. 2 is a graph showing influences on the release of high mobility group box 1 (HMGB-1), which is a liver tissue injury marker, into a perfusate in each of the control group (CON), the H₂—PV group, the H₂-HA group, and the H₂-PV+HA group at 120 minutes after reperfusion in the same experiment as that shown in FIGS. 1A to 1C. The statistical analysis was performed by one-way analysis of variance. The P value indicates significance probability.

FIGS. 3A and 3B are graphs showing influences on the vascular resistance (portal perfusion pressure: PVP) (FIG. 3A) and influences on the hyaluronic acid clearance, which is an indicator of sinusoidal endothelial cell function (FIG. 3B), in transplanted livers of the groups treated as in FIGS. 1A to 1C. ●, ▪, ▴, and ▾ in FIG. 3A indicate the same groups as those shown in FIGS. 1A to 1C. The control group (CON), the H₂—PV group, the H₂-HA group, and the H₂-PV+HA group shown in FIG. 3B are the same as those shown in FIG. 2. The statistical analysis was performed by two-way repeated measures analysis of variance in FIG. 3A and was performed by one-way analysis of variance in FIG. 3B. The P value indicates significance probability.

FIGS. 4A and 4B are graphs showing influences on the amount of bile production (bile volume), which is an indicator of transplanted liver function (FIG. 4A) and influences on the amount of LDH in bile, which is an indicator of bile duct injury of the transplanted liver (FIG. 4B), in the groups treated as in FIGS. 1A to 1C. The control group (CON), the H₂—PV group, the H₂-HA group, and the H₂—PV+HA group are the same as those shown in FIG. 2. The statistical analysis was performed by one-way analysis of variance. The P value indicates significance probability.

FIGS. 5A and 5B are graphs showing influences on the oxidative stress injury, using the level of thiobarbituric acid reactive substance (TBARS), which is a lipid peroxidation marker, as an indicator (FIG. 5A) and using the level of 8-hydroxy-2′-deoxyguanosine (8-OHdG), which is an oxidative stress marker of DNA, as an indicator (FIG. 5B), in the groups treated as in FIGS. 1A to 1C. The control group (CON), the H₂—PV group, the H₂-HA group, and the H₂—PV+HA group are the same as those shown in FIG. 2. The statistical analysis was performed by one-way analysis of variance. The P value indicates significance probability.

FIGS. 6A and 6B are graphs showing the total amount of glutathione in the transplanted liver tissue (FIG. 6A) and the molar ratio (GSH/GSSG) of reduced glutathione (GSH) to oxidized glutathione (GSSG) (FIG. 6B), in the groups treated as in FIGS. 1A to 1C. The control group (CON), the H₂—PV group, the H₂-HA group, and the H₂—PV+HA group are the same as those shown in FIG. 2. The statistical analysis was performed by one-way analysis of variance. The P value indicates significance probability.

FIG. 7 shows scanning electron micrographs (No. 1) showing the results of ultrastructural analysis of transplanted livers in the groups treated as in FIGS. 1A to 1C. The control group, the H₂—PV group, the H₂-HA group, and the H₂—PV+HA group are the same as those shown in FIG. 2. In FIG. 7, the upper panels are micrographs of ×8,000 (magnification), and the lower panels are micrographs of ×4,000 (magnification). Panels A and E are the micrographs of the control group, panels B and F are the micrographs of the H₂—PV group, panels C and G are the micrographs of the H₂-HA group, and panels D and H are the micrographs of the H₂—PV+HA group.

FIG. 8 shows transmission electron micrographs (No. 2) showing the results of ultrastructural analysis of transplanted hepatocytes in the groups treated as in FIGS. 1A to 1C. The control group, the H₂—PV group, the H₂-HA group, and the H₂—PV+HA group are the same as those shown in FIG. 2. In FIG. 8, Nu indicates the nucleus, M indicates a mitochondrion, and ER indicates an endoplasmic reticulum.

FIGS. 9A and 9B are diagrams showing the results of immunohistochemical staining of carcinoembryonic antigen related cell adhesion molecule 1 (CEACAM-1) (FIG. 9A) and a graph showing the results of image processing of the staining results shown in FIG. 9A (FIG. 9B). The control group, the H₂—PV group, the H₂-HA group, and the H₂—PV+HA group are the same as those shown in FIG. 2.

### DETAILED DESCRIPTION OF THE PREFERRED EMBODIMENTS

The present invention encompasses the following three aspects.

According to a first aspect of the present invention, a method for preventing or protecting an organ from ischemia-reperfusion injury is provided, the method comprising a step of perfusing an organ harvested for transplant ex vivo with a solution containing molecular hydrogen via a blood vessel thereof.

According to a second aspect of the present invention, a method for treating an organ is also provided, the method comprising the steps of: cold preserving an organ harvested for transplant and perfusing the cold-preserved organ with a solution containing molecular hydrogen ex vivo via a blood vessel thereof.

According to a third aspect of the present invention, an ischemia-reperfusion injury protection agent for an organ for transplant is further provided, the agent comprising a solution containing molecular hydrogen.

The above invention will now be described in detail.

### 1. Solution Containing Molecular Hydrogen

The solution containing molecular hydrogen used in the method or contained in the protection agent of the present invention can be prepared by a known method. Such a method encompasses any method that can dissolve molecular hydrogen in a solution to be applied to living bodies, and examples thereof include, but not limited to, a method in which bubbling of hydrogen gas is performed in a solution to be applied to living bodies; a method in which a molecular hydrogen-permeable bag filled with a solution to be applied to living bodies is immersed in a molecular hydrogen-containing solution (for example, see Japanese Patent No. 4486157), and a method in which a molecular hydrogen-permeable bag filled with a solution to be applied to living bodies is enclosed in a hydrogen gas-impermeable bag together with a hydrogen gas generating agent (for example, see Japanese Patent No. 5935954).

Preferred examples of the solution for dissolving molecular hydrogen include, but not limited to, organ preservation solutions, such as UW (University of Wisconsin) solution (X. Yuan et al., Transpl Int 2010; 23: 561-570), Euro-Collins solution, HTK (histidine-tryptophan-ketoglutarate) solution (M. Tahara et al., Transplantation 2005; 80: 213-221), UW-gluconate solution (developed by Belzer), Celsior solution (T. Wittwer et al., Eur J Cardiothorac Surg 1999; 15(5): 667-671), Polysol solution (K. Hata et al., Liver Transpl 2007; 13(1): 114-121), ET-Kyoto solution (M. Omasa et al., Ann Thorac Surg 2004; 77: 338-339), IGL-1 solution (J. C. Wiederkehr et al., Transplant Proc 2014; 46(6): 1809-1811), and EP-TU solution (H. Oishi et al., Surg Today 2015; 45(5): 630-633); and Ringer's solution and other physiological saline solutions to be applied to living bodies. The solution for dissolving molecular hydrogen is preferably an organ preservation solution.

The component composition of the organ preservation solution varies depending on the type of the preservation solution. For example, the component composition of 1000 mL of UW-gluconate solution (developed by Belzer) consists of 0.68 g of adenine (free base), 0.068 g of calcium chloride (dihydrate), 1.80 g of dextrose (+), 0.92 g of glutathione (reduced form), 2.38 g of HEPES (free acid), 50.0 g of hydroxyethyl starch, 1.13 g of magnesium gluconate (anhydrous), 5.4 g of mannitol, 3.4 g of potassium phosphate (single base), 0.75 g of D-ribose (−), 17.45 g of sodium gluconate, 0.70 g of sodium hydroxide, and sterilized water added up to 1000 ml.

The concentration of molecular hydrogen in the solution is not higher than the saturation concentration of molecular hydrogen (1.6 ppm at normal temperature and normal pressure of 15° C. to 25° C. and 1 atm), preferably 0.5 to 1.2 ppm, and more preferably 0.8 to 1.2 ppm. A solution containing molecular hydrogen in a concentration higher than the saturation concentration is not preferred because, during ex vivo perfusion via a blood vessel of an organ, hydrogen enters the organ as a gas. Conversely, a too low concentration of dissolved hydrogen decreases the effect of preventing ischemia-reperfusion injury by molecular hydrogen or increases the time required for ex vivo perfusion.

The protection agent of the present invention consists of the solution containing molecular hydrogen and is used before transplant to a recipient for preventing or protecting the organ for transplant from ischemia-reperfusion injury.

In the ex vivo perfusion of an organ, if necessary, a gas mixture composed of about 95% oxygen and about 5% carbon dioxide may be further dissolved in the protection agent of the present invention until saturation, or the gas mixture may be supplied to an organ perfusion system (described below).

### 2. Organ for Transplant

The organ as an object of the present invention is an organ that can be harvested from the body of a donor animal and can be transplanted into a recipient animal, and examples thereof include, but not limited to, a liver, a kidney, a pancreas, a lung, a heart, and an intestine (e.g., small intestine).

The donor and recipient animals are mammals and are preferably humans.

3. Treatment of Organ with Solution Containing Molecular Hydrogen

The solution or protection agent containing molecular hydrogen according to the present invention can be used, but not limited to, during or after cold preservation of an organ for transplant, during or after warm preservation of an organ for transplant, or in treatment (also referred to as “processing”) of an organ for transplant before the transplant (e.g., immediately before the transplant) of the organ.

Examples of the cold preservation method include a low-temperature perfusion preservation method (hypothermic MP (HMP): 4° C. to 10° C.) and a simple cold preservation method (static cold storage (SCS): 4° C.) (Koichiro Hata et al., Organ Biology 2017; 24(2): 61-67 (Japan)). Here, “MP” is an abbreviation for machine perfusion, which supplies oxygen and nutrients and removes wastes by ex vivo perfusion after an organ is harvested for reducing ischemia-reperfusion injury or evaluating or improving the graft function. The SCS is a method in which a harvested organ is merely immersed in a cold preservation solution.

Examples of the warm preservation method include a constant temperature/body temperature perfusion preservation method (normothermic MP (NMP) 35° C. to 37° C.) and a room temperature perfusion preservation method (subnormothermic MP (SMP): 20° C. to 25° C.).

The method for treating an organ and the method for preventing ischemia-reperfusion injury according to the present invention includes a step of perfusing a harvested organ ex vivo with the protection agent or the solution containing molecular hydrogen via a blood vessel thereof. The organ is perfused for a predetermined time and is then transplanted into a recipient. The ischemia-reperfusion injury of the transplanted organ is significantly prevented or reduced by these methods.

In the present invention, an organ may be harvested from the body and then cold preserved during ex vivo perfusion of the organ with a hydrogen-containing solution via a blood vessel thereof, or a harvested organ may be cold preserved (e.g., SCS) and then perfused with a hydrogen-containing solution via a blood vessel thereof. In the cold preservation, the organ can be immersed in a commonly used preservation solution of 2° C. to 6° C. (e.g., 4° C. to 6° C.) for a period of 24 hours or less. The methods of the present invention can prevent, reduce, or protect ischemia-reperfusion injury of organs even after preservation by SCS. Although it is known that organ cell injury is caused in organs preserved by SCS, the organs treated with the method of the present invention after SCS preservation can be significantly prevented or reduced from ischemia-reperfusion injury.

The protection agent or the solution containing molecular hydrogen of the present invention may have any temperature ranging from the cold preservation that does not adversely affect the organ (e.g., 4° C. to 10° C.) to room temperature (e.g., 20° C. to 25° C.). The period of time for perfusion with the protection agent or the solution containing molecular hydrogen varies depending on the type and size of the organ and can be, for example, about 5 minutes to about 1 hour, and can be longer than 1 hour in some cases.

Although the blood vessel for introducing the protection agent or the solution containing molecular hydrogen into the donor organ is usually an artery, a vein also can be used depending on the type of the organ. For example, a liver may be perfused via the main artery (artery perfusion) or may be perfused via the portal vein (portal vein perfusion). Since the effects of the artery perfusion and the portal vein perfusion are different from each other, both the artery perfusion and the portal vein perfusion may be simultaneously performed. On this occasion, the proportion of the amount of the artery perfusion to the amount of the portal vein perfusion may be adjusted according to the purpose.

In ex vivo perfusion with the protection agent or the solution containing molecular hydrogen via a blood vessel of an organ, for example, an organ perfusion system can be used. The system can include an appropriate combination of, for example, a container that can preserve organs and control the temperature for maintaining the organs; a pump that can control the flow rate of a solution (preferably, an explosion proof type); a reservoir for storing a protection agent or a solution containing molecular hydrogen; a supply system of a gas mixture of oxygen and carbon dioxide; a supply system of hydrogen gas (as needed); a measurement (using a sensor) and monitoring system and a control system for the temperature, pH, and gas (oxygen and hydrogen) concentration of a perfusate; a flowmeter; a pressure manometer (as needed); and tubes connecting each element (for example, see U.S. Pat. No. 7,410,474 B1).

When the organ is, for example, liver, between the liver portal vein and the inferior vena cava and/or between the hepatic artery and the inferior vena cava can be perfused with the protection agent or the solution containing molecular hydrogen through the reservoir (capable of monitoring and controlling, for example, the temperature, pH, hydrogen concentration and oxygen concentration) storing them with a pump for a predetermined time.

It is possible to evaluate the function of the organ (and its cells) by sampling the perfusate during ex vivo perfusion and to judge the risk of causing ischemia-reperfusion injury defined above. For example, in a case of liver, it is possible to measure the release (or emission) of hepatocellular injury markers, i.e., transaminase, such as ALT or AST, and LDH; to measure the portal venous pressure (PVP) after reperfusion; to measure the artery perfusion pressure; to measure the hyaluronic acid clearance value (sinusoidal endothelial injury); and to measure the oxidative stress injury. In other organs, such as heart, lung, kidney, pancreas, and intestine, the function of each organ (and its cells) can be evaluated by known measurement methods.

The present invention will be described in more detail by the following Examples, but the technical scope of the present invention is not limited to the following Examples.

### Examples

### 1. Materials and Methods

### <Preparation of Organ>

The liver was completely harvested from each of Wistar male rats (weight: 270 to 320 g) and was cold preserved (4° C.) in UW (University of Wisconsin) solution for 24 hours.

### <Preparation of Hydrogen-Containing Preservation Solution>

Hydrogen was dissolved in a preservation solution by a non-destructive hydrogen-containing process (Japanese Patent No. 5935954 (MiZ Co., Ltd. (Japan)) to prepare a hydrogen-containing preservation solution. Specifically, a sterilized infusion bag containing Ringer's solution (500 mL, manufactured by Fuso Pharmaceutical Industries, Ltd. (Japan)) was put in an aluminum bag together with a moistened hydrogen-generating agent (manufactured by MiZ Co., Ltd.) and was vacuum treated. The aluminum bag was left to stand at room temperature for about 24 hours to generate hydrogen for aseptically dissolving hydrogen in the Ringer's solution in the infusion bag. The hydrogen concentration in the preservation solution was 1 mg/L (1 ppm) when measured using a dissolved hydrogen concentration measuring reagent (manufactured by MiZ Co., Ltd.) with an electrochemical hydrogen meter (model: DHD1-1, manufactured by DKK-TOA Corporation).

### <Evaluation of Organ>

Four groups each consisting of 10 liver specimens cold preserved for 24 hours as described above were subjected to the following perfusion treatment [1] to [4], respectively, and were then subjected to ex vivo oxygenation and perfusion (37° C., 2 hours), which is an evaluation system of an organ for transplant. Subsequently, liver injury and liver function were measured.

[1] a group subjected to perfusion with 40 mL of normal Ringer's solution warmed to 25° C. and not containing hydrogen via the portal vein (hereinafter, referred to as the control group);

[2] a group subjected to perfusion with 40 mL of Ringer's solution warmed to 25° C. and containing hydrogen (1.0 ppm) via the portal vein (hereinafter, referred to as H₂—PV group);

[3] a group subjected to perfusion with 40 mL of Ringer's solution warmed to 25° C. and containing hydrogen (1.0 ppm) via the hepatic artery (hereinafter, referred to as H₂-HA group); and

[4] a group subjected to perfusion with 40 mL of Ringer's solution and 20 mL of Ringer's solution warmed to 25° C. and containing hydrogen (1.0 ppm) via both the portal vein and the hepatic artery, respectively, (hereinafter, referred to as H₂—PV+HA group).

The measured values were statistically analyzed. That is, in the case of a parameter at only a single point of time, one-way analysis of variance (1-way ANOVA) was performed. When there is a statistically significant difference, a post-hoc test is further performed as multiple comparison to verify the statistically significant difference between the control group and the H₂—PV group, the H₂-HA group, or the H₂—PV+HA group. In the case of a parameter changing over time, two-way repeated measures analysis of variance (2-way repeated measured ANOVA) was performed. When there is a statistically significant difference, as in above, a post-hoc test is performed as multiple comparison to verify the statistically significant difference between the control group and the H₂—PV group, the H₂-HA group, or the H₂—PV+HA group. The mean±standard error of the measured data was determined. The statistically significant difference between each group was defined to be statistically significant when p<0.05.

### 2. Results

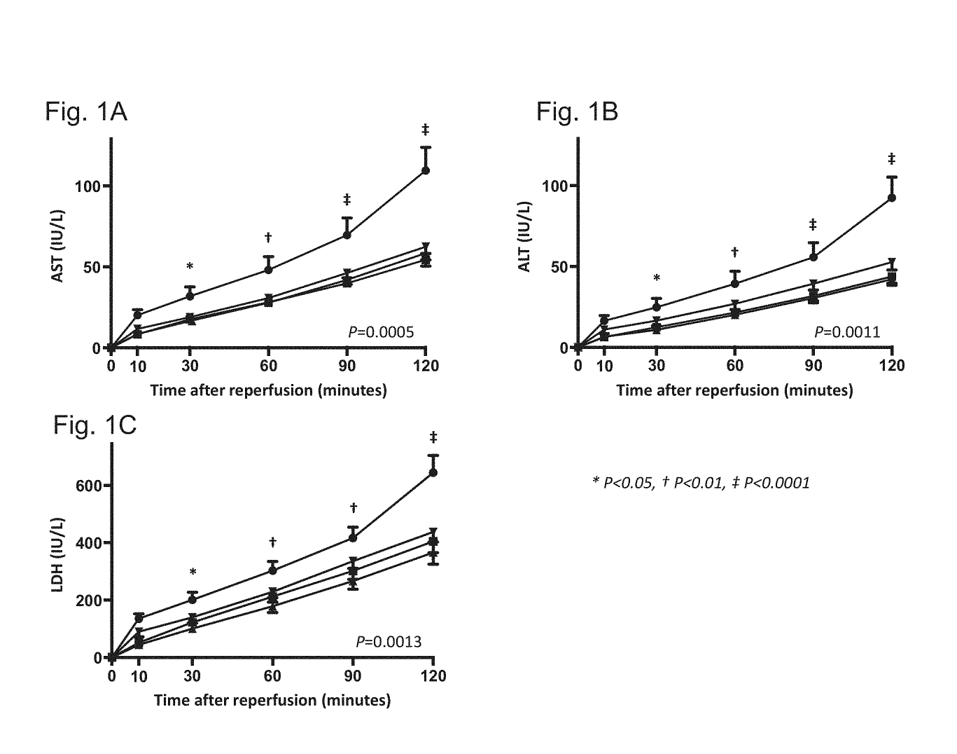

The influence in each of the groups on the release of transaminase and lactate dehydrogenase (LDH), which are hepatocellular injury markers, are shown in FIGS. 1A to 1C. The results of aspartate aminotransferase (AST), alanine aminotransferase (ALT), and lactate dehydrogenase (LDH) shown in FIGS. 1A to 1C were subjected to analysis of variance to show statistically significant differences with p=0.0005, p=0.0011, and p=0.0013, respectively. A multiple comparison test was further performed, and all the markers showed statistically significant differences between the control group and the H₂—PV group, the H₂-HA group, or the H₂—PV+HA group (p<0.05, p<0.01, or p<0.0001, respectively). The results show that in the group treated with the hydrogen-containing preservation solution, the release of transaminase is prevented and that the hepatocellular injury is extremely slight.

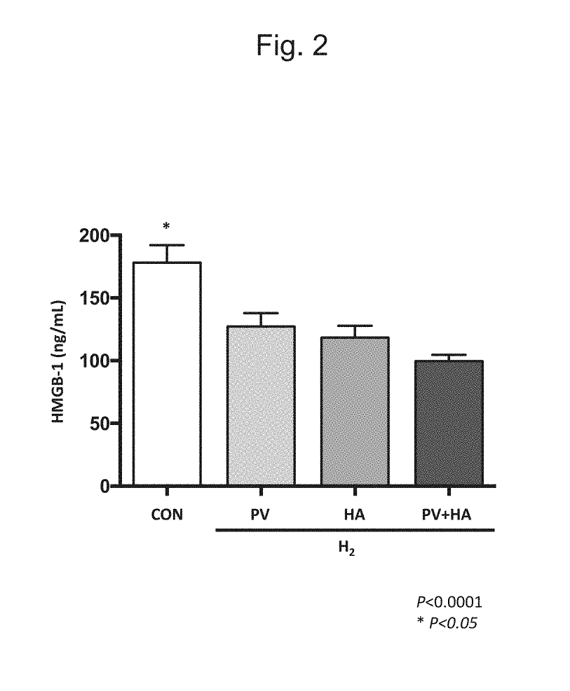

The influence on the release of HMGB-1 (high mobility group box 1), which is a hepatocellular injury marker, is shown in FIG. 2. The results were subjected to analysis of variance to show a statistically significant difference with p<0.0001. A multiple comparison test was further performed, and the marker showed statistically significant differences (p<0.05) between the control group and the H₂—PV group, the H₂—HA group, or the H₂—PV+HA group. The results also show that in the group treated with the hydrogen-containing preservation solution, the release of HMGB-1 is prevented and that, similarly, the hepatocellular injury is extremely slight.

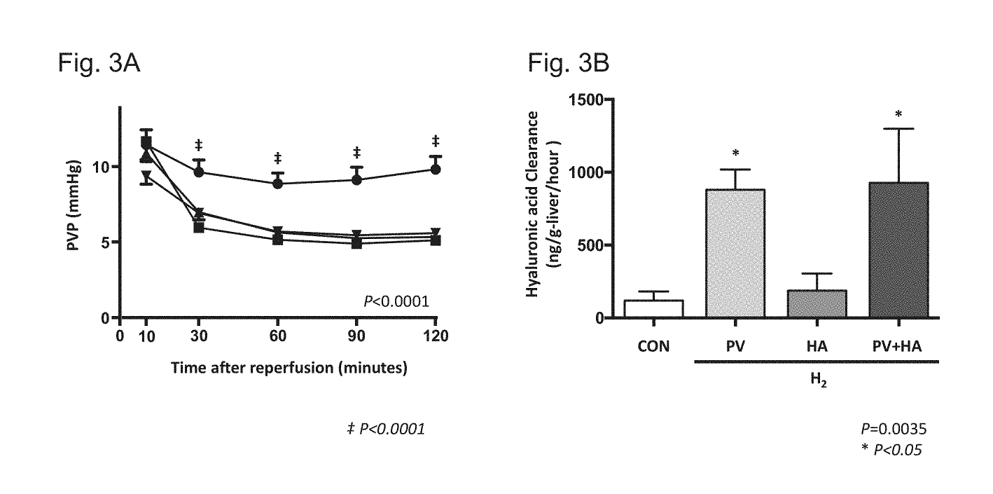

The influences on the vascular resistance of the portal vein and hyaluronic acid clearance (HA clearance) are shown in FIG. 3A and FIG. 3B, respectively. Analysis of variance of the portal venous pressure (PVP) after reperfusion showed a statistically significant difference with p<0.0001, and a multiple comparison test showed statistically significant differences (p<0.0001) between the control group and the H₂—PV group, the H₂—HA group, or the H₂-PV+HA group. Analysis of variance of the HA clearance showed a statistically significant difference with p=0.0035, and a multiple comparison test showed a statistically significant difference (p<0.05) between the control group and the H₂—PV group or between the control group and the H₂—PV+HA group. The results demonstrate that portal perfusion with a hydrogen-containing preservation solution is effective for maintaining sinusoidal endothelial cells, whereas artery perfusion is not effective for maintaining sinusoidal endothelial cells.

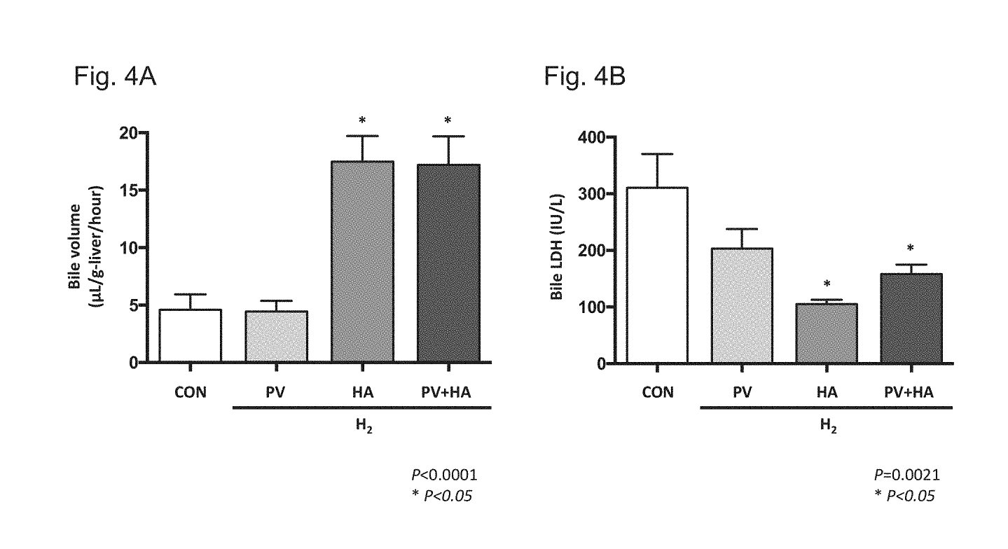

The influences on the amount of bile production and the amount of LDH in bile are shown in FIG. 4A and FIG. 4B. Analysis of variance of the amount of bile production and the amount of LDH showed statistically significant differences with p<0.0001 and p=0.0021, respectively, and a multiple comparison test showed a statistically significant difference (p<0.05) between the control group and the H₂—HA group or between the control group and the H₂-PV+HA group in every measured value. The results demonstrate that artery perfusion with a hydrogen-containing preservation solution is effective for reducing the amount of bile production and bile duct injury, whereas portal perfusion is not effective for reducing the amount of bile production and bile duct injury.

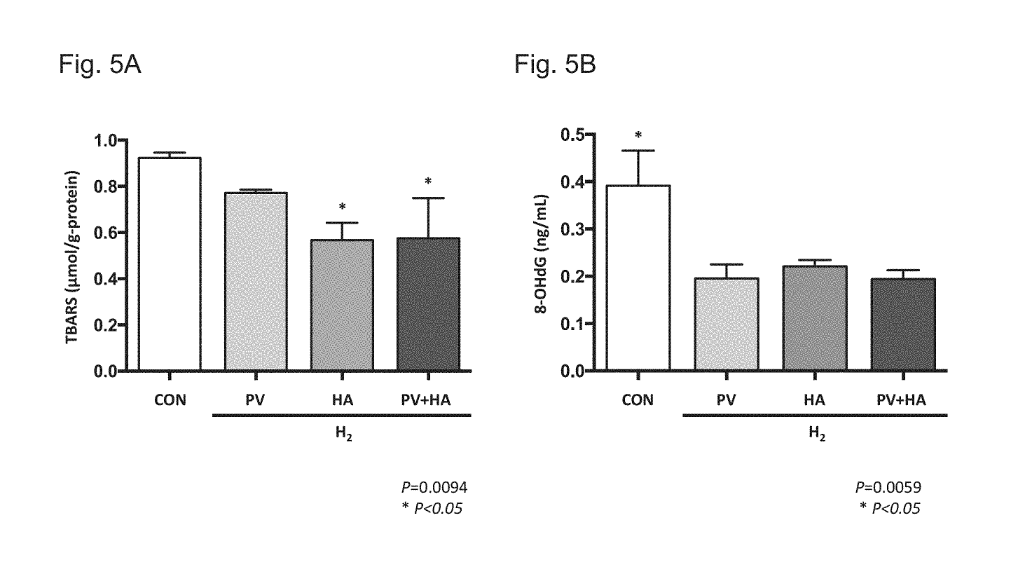

The influences on oxidative stress injury are shown in FIG. 5A and FIG. 5B. Analysis of variance of thiobarbituric acid reactive substance (TBARS), which is a lipid peroxidation marker, showed a statistically significant difference with p=0.0094, and a multiple comparison test showed a statistically significant difference (p<0.05) between the control group and the H₂-HA group or between the control group and the H₂—PV+HA group. The results demonstrate that artery perfusion with a hydrogen-containing preservation solution is effective for preventing lipid peroxidation, whereas the degree of the prevention of lipid peroxidation by portal perfusion is small. Analysis of variance of 8-OHdG, which is an oxidative stress marker of DNA, showed a statistically significant difference with p=0.0059, and a multiple comparison test showed a statistically significant difference (p<0.05) between the control group and the H₂—PV group, the H₂-HA group, or the H₂—PV+HA group. The results demonstrate that both portal perfusion and artery perfusion are effective for reducing oxidative stress of DNA.

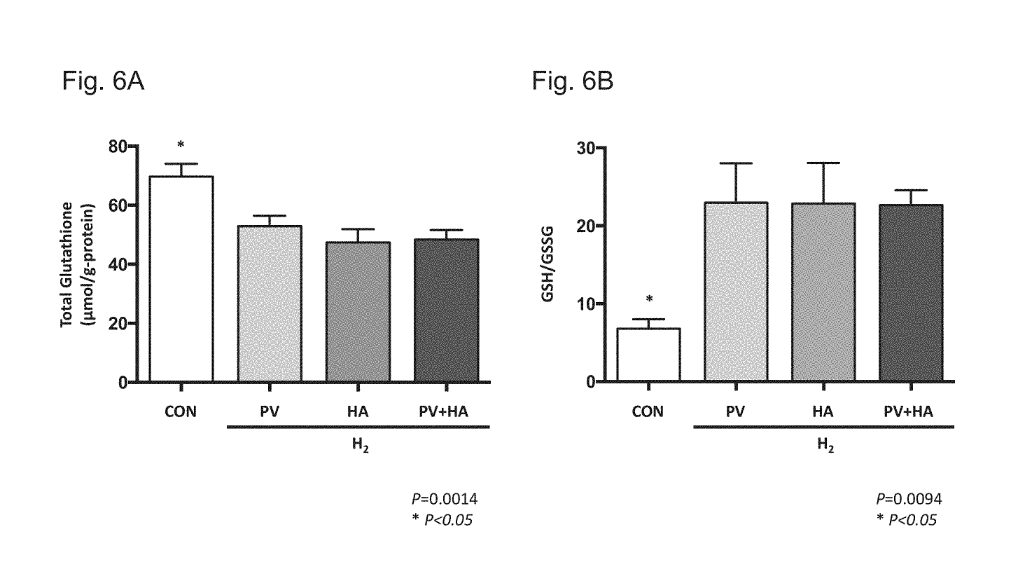

The total amount of glutathione and the ratio (GSH/GSSG) of reduced glutathione (GSH) to oxidized glutathione (GSSG), which are indicators of antioxidant potential of a tissue, are shown in FIG. 6A and FIG. 6B, respectively. Analysis of variance of the total amount of glutathione and the ratio GSH/GSSG showed statistically significant differences with p=0.0014 and p=0.0094, respectively, and a multiple comparison test showed a statistically significant difference (p<0.05) between the control group and the H₂—PV group, the H₂-HA group, or the H₂—PV+HA group in every measured value. The results demonstrate that both portal perfusion and artery perfusion are effective against the oxidative stress and the redox indicator (GSH/GSSG).

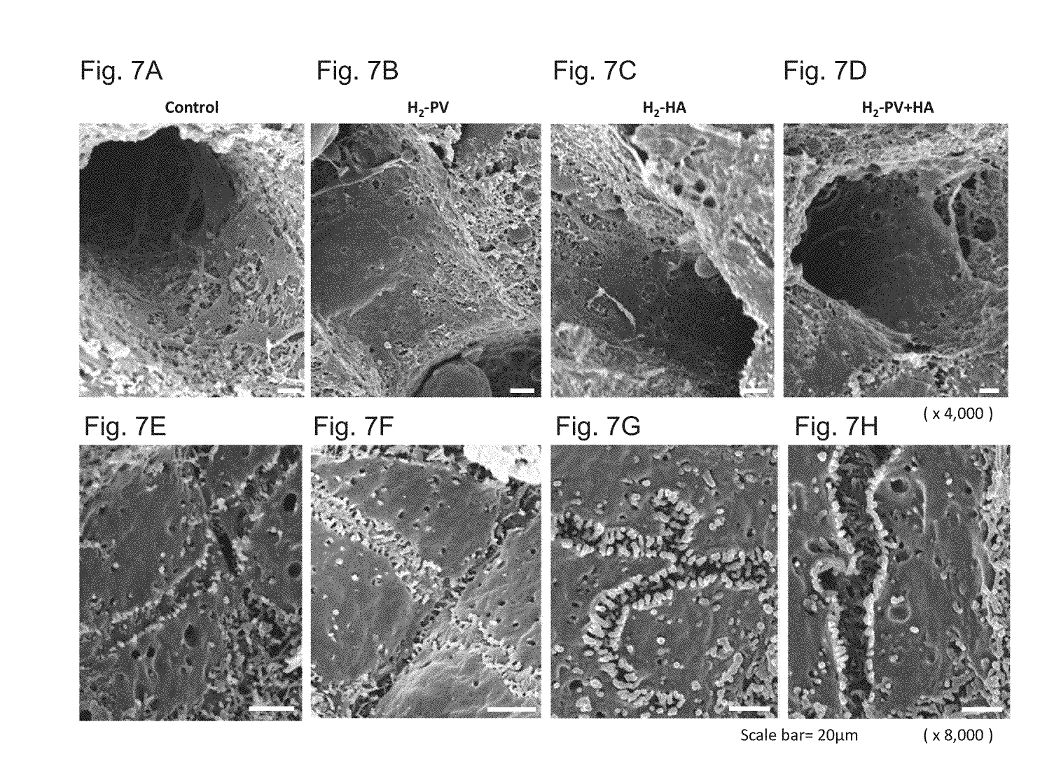

The results of ultrastructural analysis (electron microscopic observation) of the livers are shown in FIG. 7. As observed in the sinusoidal endothelial cells (A to D on the upper stage of FIG. 7), in the control group (A), the intracellular space was large, and the sinusoidal endothelial pores were enlarged and sparse. In contrast, in each of the groups (B to D) perfused with a hydrogen-containing preservation solution, the livers were kept healthy. The results observed in the H₂—PV group (B), the H₂—PV+HA group (D), and the H₂-HA group (C) were good in this order. That is, the injury of sinusoidal walls (microcirculation, A to D) of the transplanted livers was reduced by perfusion with a hydrogen-containing preservation solution, and the effect of protection by the perfusion via the portal vein was higher than that by the perfusion via the hepatic artery. As also observed in the microvilli structure of bile canaliculus (E to H on the lower stage of FIG. 7), in each of the groups (F to H) perfused with a hydrogen-containing preservation solution, the microvilli structure was well maintained, compared to the control group (E). The results observed in the H₂-HA group (G), the H₂—PV+HA group (H), and the H₂—PV group (F) were good in this order. That is, injury of the bile canaliculus of the transplanted livers was reduced by perfusion with a hydrogen-containing preservation solution via the hepatic artery, but the effect of protection by the perfusion via the portal vein was unclear. These results demonstrate that portal perfusion with a hydrogen-containing preservation solution shows an excellent effect of protecting the sinusoidal endothelial cells of a liver and that artery perfusion with a hydrogen-containing preservation solution shows an excellent effect of protecting the villi structure of a small bile duct.

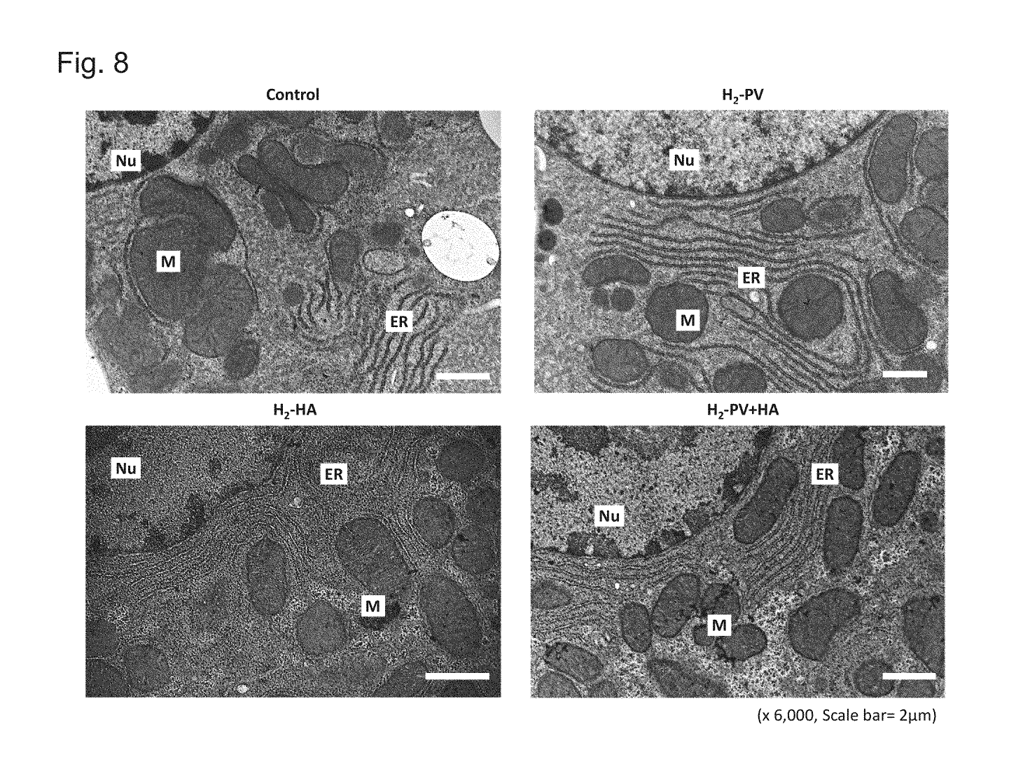

Similarly, the results of ultrastructural analysis (electron microscopic observation) of hepatocytes are shown in FIG. 8. In the control group, ballooning degeneration of mitochondrion (M) was observed. In contrast, in each of the groups (the H₂—PV group, the H₂-HA group, and the H₂—PV+HA group) perfused with a hydrogen-containing preservation solution, relatively good observations were obtained. No clear difference was observed between the microstructures of the groups (the H₂—PV group, the H₂-HA group, and the H₂—PV+HA group) perfused with a hydrogen-containing preservation solution.

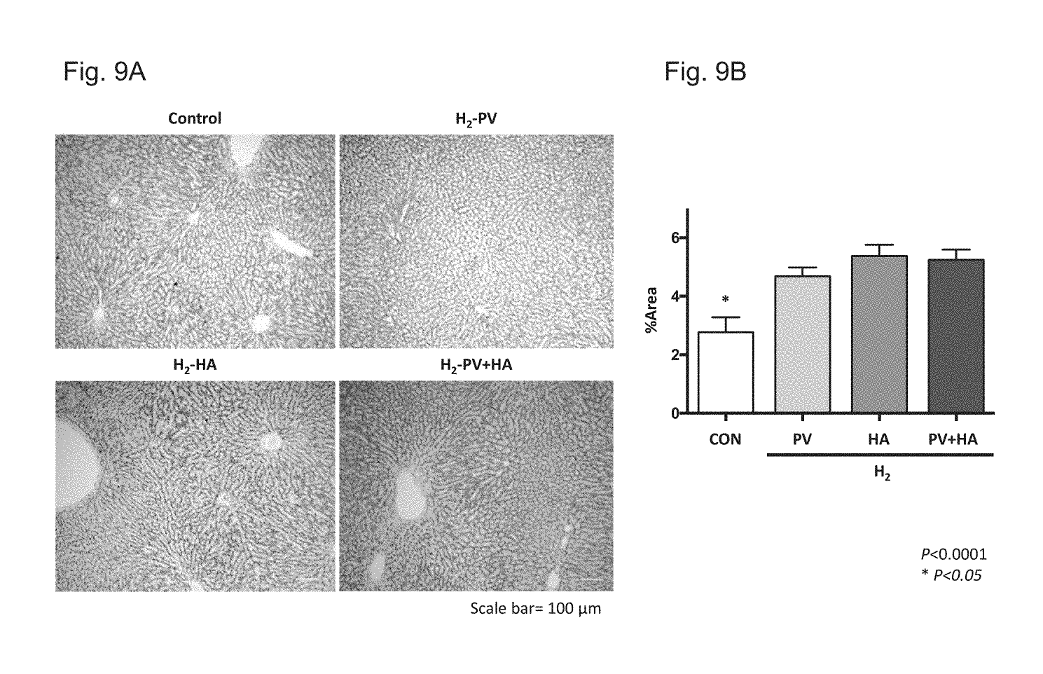

FIG. 9A shows the results of immunohistochemical staining of carcinoembryonic antigen related cell adhesion molecule 1 (CEACAM-1). CEACAM-1 shows important roles in the adhesion of hepatocytes to the small bile duct or bile canaliculus and the morphological maintenance, and the region stained with brown by immunohistochemical staining is a healthy small bile duct or bile canaliculus. The stainability was strong in each of the groups perfused with a hydrogen-containing preservation solution, compared to that in the control group. The staining results were quantified with image analysis software (FIG. 9B). Analysis of variance of the results showed a statistically significant difference with p<0.0001, and a multiple comparison test showed a statistically significant difference (p<0.05) between the control group and the H₂—PV group, the H₂-HA group, or the H₂—PV+HA group.

The world standard method of organ preservation is still a simple cold preservation method. According to the results described above, after normal cold preservation, ischemia-reperfusion injury could be remarkably prevented by only perfusing an organ for transplant with a hydrogen-containing preservation solution via a blood vessel (e.g., an artery and/or vein) thereof, for example, via a portal vein and/or hepatic artery when the organ is liver.

### INDUSTRIAL APPLICABILITY

According to the present invention, in liver transplantation or other organ transplantation, ex vivo perfusion with a hydrogen-containing solution via a blood vessel of the organ can be effectively used for preventing or reducing ischemia-reperfusion injury.

1. A method for preventing or protecting an organ from ischemia-reperfusion injury, the method comprising a step of perfusing an organ harvested for transplant ex vivo with a solution containing molecular hydrogen via a blood vessel thereof.

2. A method for treating an organ, the method comprising the steps of:
cold preserving an organ harvested for transplant; and
perfusing the cold-preserved organ ex vivo with a solution containing molecular hydrogen via a blood vessel thereof.

3. The method according to claim 1, wherein
the solution is an organ preservation solution.

4. The method according to claim 1, wherein
the concentration of molecular hydrogen in the solution containing molecular hydrogen is 1.6 ppm or less.

5. The method according to claim 1, wherein
the period of time for perfusing the harvested organ ex vivo with the solution containing molecular hydrogen via the blood vessel thereof is 5 minutes to 1 hour.

6. The method according to claim 1, wherein
the blood vessel of the harvested organ is a portal vein and/or a hepatic artery.

7. An ischemia-reperfusion injury protection agent for an organ for transplant, the agent comprising a solution containing molecular hydrogen.

8. The protection agent according to claim 7, wherein
the concentration of molecular hydrogen in the solution containing molecular hydrogen is 1.6 ppm or less.

9. The protection agent according to claim 7, wherein
the solution is an organ preservation solution.

10. The method according to claim 2, wherein
the solution is an organ preservation solution.

11. The method according to claim 2, wherein
the concentration of molecular hydrogen in the solution containing molecular hydrogen is 1.6 ppm or less.

12. The method according to claim 2, wherein
the period of time for perfusing the harvested organ ex vivo with the solution containing molecular hydrogen via the blood vessel thereof is 5 minutes to 1 hour.

13. The method according to claim 2, wherein
the blood vessel of the harvested organ is a portal vein and/or a hepatic artery.
